(19) United States
(12) Patent Application Publication
(10) Pub. No.: US 2026/0103895 A1
(43) Pub. Date: Apr. 16, 2026

(54) Method for mounting panels and a mounting element for insertion into panel holes

(71) Applicant: DISSING A/S, Skanderborg (DK)

(72) Inventor: Claus Hornstrup Dissing, Ry (DK)

(73) Assignee: DISSING A/S, Skanderborg (DK)

(21) Appl. No.: 19/112,426

(22) PCT Filed: Sep. 12, 2023
(86) PCT No.: PCT/DK2023/050220

§ 371 Date: Mar. 17, 2025

(30) Foreign Application Priority Data
Sep. 16, 2022 (DK) PA202270452

(51) Int. Cl. E04F 13/08

(52) U.S. Cl. CPC E04F 13/0846

(57) ABSTRACT

A panel, for example facade panel. is mounted to a support structure, for example a wall, by using spacer inserts (1) in fixation holes (3) of a facade panel (2). The spacer insert (1) comprises an outer circular ring (4) for abutting an inner rim (3A) of the fixation hole (3) and comprises vanes (5) extending from the ring (4) inwards towards a central region (7) of the ring (4) but not to the center (6) of the ring (4) so as to leave open a central guiding passage (8) for a screw (17) or nail for fastening the panel (2) against a support structure by the screw (17) or nail. The vanes (3) are resilient for allowing lateral movement of the ring (4) and the panel (2) relatively to the fastened screw (17) or nail extending through the guiding passage (8).

### FIELD OF THE INVENTION

The present invention relates to method for fastening and holding panels, in particular facade panels, on a support structure, for example on a wall, and a mounting element comprising a spacer insert for insertion into fixation holes of the panel, in particular according to the preamble of the independent claims.

### BACKGROUND OF THE INVENTION

When facades of buildings are covered with facade panels, it is common practice to screw the panels to a substructure of metal or wood. Temperature variations causes expansion and contraction of the panels, leading to tension in the material around the fastening points. In particular, fiber cement facade panels are also subject to a significant swelling and shrinking behavior depending on the humidity, which leads to further tension. In worst case, expansion and contraction may result in breakage of the panels. Alu panels do not suffer from breakage but have a tendency to bend when expanding, which is also unwanted. Additionally, there is a risk for the panels to slide off the screws.

The problem of tension around the mounting area increases if the screw is not properly centered. It is therefore important to center the screw properly in the fixation holes. Such shrinking and expansion behavior and proper centering of the screws must be taken into account when installing the facade panels.

In order to prevent breakage, the mounting holes through which the corresponding screws are driven for connection to the substructure are formed with a considerably larger diameter as compared to the diameter of the fasteners. However, oversized holes is not a sufficient technical solution due to the following. Although, the oversized holes compensate for expansions and contraction of the panels, the panels attached to the wall are not sufficiently fixed but can be moved with considerable play in the assembled state relative to the screw, which should be avoided. Furthermore, dust, sand, rainwater, snow, and other pollutants can make their way through the oversized mounting holes and into the volume behind the facade panels, which can result in damage over the years. In the case of fiber cement panels, water also penetrates into the panel material in the area of the fastening holes, resulting in visible stains around the fastening hole.

In order to secure that the mounting screws are centered within the oversized holes, inserts are provided in the oversized holes and a screw driven through the insert, which centers the screw in the hole when the screw. Examples are disclosed in international patent applications WO2018/171895 and WO2021/004756. However, such insert do not allow for sufficient movements of the panel relatively to the screw, which may create tension around the hole.

In order to allow movement of the panel relatively to the screw, international patent application WO2017/125166 discloses an insert with a disc having the size of the holes in the facade panel and which is inserted into the hole. A collar on one side of the disc rests against the outer surface of the panel at the rim of the hole. The disc has a central opening that centers the screw in the hole when inserted for screwing it into the underlying support structure. Once, the screw is driven through the central portion of the disc, a portion breaks away so that the screw is no longer held in place by the disc, and the panel can move relatively to the centered screw. The head of the screw is wider than the collar and tightens against the collar for preventing dust and other debris to enter the hole from the outer side of the panel. Although, this solution is in many ways practical, it suffers from the drawback that the insert may break before the screw has been screwed into the underlying support structure, which implies the risk that the screw is not properly centered during the typically quick mounting procedure of the facade panels.

European patent application EP1876314 discloses an insert having a plugging section with an outer diameter equal to the diameter of a fastening hole of the facade panel. The insert has a through hole for centering of a screw during mounting and for play-free accommodation of it after mounting. The unit is formed as single piece from an elastic plastic which has vanes that extend radially outwardly from the central screw-accommodating portion to the rim of the through hole. By deformation, the vanes take up relative movements between the facade panel and the fastening unit. A sealing lip is formed at the section for sealing the fastening hole against external moisture. This insert has a disadvantage in that the lip extends to the rim of the hole and hampers movements of the panel relatively to the hole.

WO2013/076494 discloses an insert with a ring to abut the inner rim of the hole and center portion for centering the screw as well as a spring-like arrangement between the center portion and the ring for allowing movements between the panel and the screw. This insert consists of multiple pieces and is rather complex and expensive in manufacture in addition to requiring relatively long time in the mounting process.

US2021/0388621A1 discloses and insert in which the screw is centered by three spiral shaped arms. Due to the spiral configuration, the elasticity is not symmetrical, which is not optimum.

For many of the inserts on the market and disclosed in the prior art, there is a further general disadvantage in that they have to be oriented in a specific way. It must be recalled that workers that mount facade panels are often paid according to the number of facade panels mounted, which requires that the mounting should be as quickly as possible. Even minor improvements with respect to speed of mounting is welcome and desired.

Accordingly, there is still need for improvements. In particular, it would be desirable to provide inserts that is robust, easy to manufacture, reliable in function. It would also be desirable to provide an insert that avoids the need for specific orientation.

### DESCRIPTION/SUMMARY OF THE INVENTION

It is therefore an objective of the invention to provide an improvement in the art and avoid disadvantages of the prior art. In particular, it is an objective to provide an insert for facade panels which centers the screw during mounting, and which allows for movement of the facade plate relatively to the screw after mounting. Another objective is to provide an insert which avoids time for finding correct orientation. These objectives and further advantages are achieved with a mounting element comprising a spacer insert and a method for mounting a panel on a support structure as described below and in the claims.

When mounting a panel to an underlying support structure, for example mounting a facade panel to a wall, where screws extend through holes in the panel, resilient spacer inserts, as described in the following, are inserted into the holes for centering the screws in the holes and facilitating the fastening procedure. The spacer inserts are dimensioned to fit, for example fit snugly, into the holes, which are oversized relatively to the screw thread. The spacer inserts allow sufficient play of the panel relatively to the position-wise fixed screws in order for the panel not to break during later expansion and contraction caused by temperature changes and/or humidity.

The panel is provided with oversized holes, relatively to a screw diameter, and the resilient spacer inserts fit the size of the holes when inserted into the holes. While the panel is positioned against the support structure, screws are driven into the underlying support structure, each screw extending through a guiding passage in the respective spacer insert, which centers the screw relatively to the hole.

The spacer insert comprises a circular ring configured for abutting an inner rim of the fixation hole in the panel. Further, it comprises flexible vanes that extend, for example extend radially, from the ring inwards towards a central region of the ring but not to the center of the ring so as to leave open a central guiding passage for the screw, or alternatively a nail. In particular, the vanes are fastened only to the ring but not to a central cylinder, as in the prior art. Instead, the vanes have freestanding ends, forming the guiding passage through the central region During the fastening procedure, a screw is inserted into and through the guiding passage with the vanes abutting the screw, and the screw is tightened into the support structure, or alternatively, directly into the wall.

The spacer insert comprises at least three vanes, although, typically, more vanes are provided, for example 4, 5, 6, 7, 8, 9 or 10 vanes but typically not more than 15.

Typically, the spacer insert is inserted into the hole, first, and the screw inserted into the guiding passage thereafter and tightened. However, this is not strictly necessary. It is also possible to select a screw with a thread diameter larger than a diameter W of the guiding passage and first inserting the screw into the guiding passage for providing a combination of screw and spacer insert, where the spacer insert is held by the screw due to the flexible vanes holding around the screw threading. Only then, as part of the combination, the spacer insert is inserted into the hole, while the screw extends through the guiding passage, after which the screw is tightened into the support structure, for example metal or wooden support structure or directly into a wall.

Although, the invention is particularly useful for facade panels, it can also be used for other types of panels fastened to a support structure, for example a support structure of metal or wood, for example a frame.

For facade panels the following mounting procedure is useful. In order for not the entire panel being movable, it is advantageous to fasten a central part of the panel non-movably to the support structure. For this case, the panel is provided with fixation holes in edge regions of the panel and with a central hole in a central part of the panel. The panel is then firstly fastened to the support structure, with a screw through the central hole, typically by using a screw-centering bushing in the central hole. Position-wise, this fixes the central part of the panel non-movably to the support structure. The bushing is different from the spacer inserts in that it prevents the panel from moving laterally, for example laterally relatively to a wall. Once, the central part of the panel is fixed, further screws are driven through the spacer inserts in the fixation holes in the edge regions, for example corner regions. As the spacer inserts at the edge parts of the panel are resilient, they allow lateral floating movement of the edge parts of the panel relatively to the position-wise fixed screws or nails in the edge parts and relatively to the fixed central part of the panel.

In case that the panel is fastened directly to the wall, the wall takes the role of a support structure.

In some embodiments, the ends of the vanes around the guiding passage are straight and parallel to a central axis of the ring.

Optionally, the vanes are wedge-shaped, narrowing towards the central region, which makes them more flexible near the central guiding passage.

In some practical embodiments, the open central guiding passage has a diameter in the range of 20-70% of an inner diameter of the ring. As an option, the length of the vanes is in the range of 15-40% of the inner diameter of the ring. For example, the sum of the diameter of the open central guiding passage and twice the length of the vanes is 100% of the inner diameter of the ring.

For example, the ring has a first outer face, advantageously first conical outer face, for insertion into the fixation hole and for abutting the inner rim of the fixation hole. In extension of the first outer face, the ring has a collar with larger diameter than the first outer face for resting on an edge of the hole when the first outer face is inserted into the hole. The ring has a second outer face, advantageously second conical outer face, in extension of the collar on the opposite side of the collar relatively to the first outer face. The first and/or the second outer face are advantageously tapering, such as conical, with decreasing diameter with distance from the collar for ease of insertion into the hole. The first and second outer faces and the collar are advantageously symmetrical with respect to a symmetry plane perpendicular to the central axis.

In general, it is an advantage of the spacer insert is symmetrical with respect to a plane perpendicular to the central axis, as the spacer insert can be inserted into the holes with either of two different orientations, so that effort and time for adjusting the right orientation during mounting are minimized.

In some useful embodiments, spacer insert is made of a material having a hardness of in the range of Shore A 50-Shore A 95.

### SHORT DESCRIPTION OF THE DRAWINGS

The invention will be explained in more detail with reference to the drawing, where

FIG. 1 illustrates mount of a wall panel against a wall;

FIG. 2 shows a combination of a spacer insert and a screw;

FIG. 3 illustrates a spacer insert is detail in perspective view;

FIG. 4A shows a technical drawing of a head-on view of the spacer insert and

FIG. 4B shows a quarter section of the technical drawing of FIG. 4A in greater detail.

### DETAILED DESCRIPTION/PREFERRED EMBODIMENT

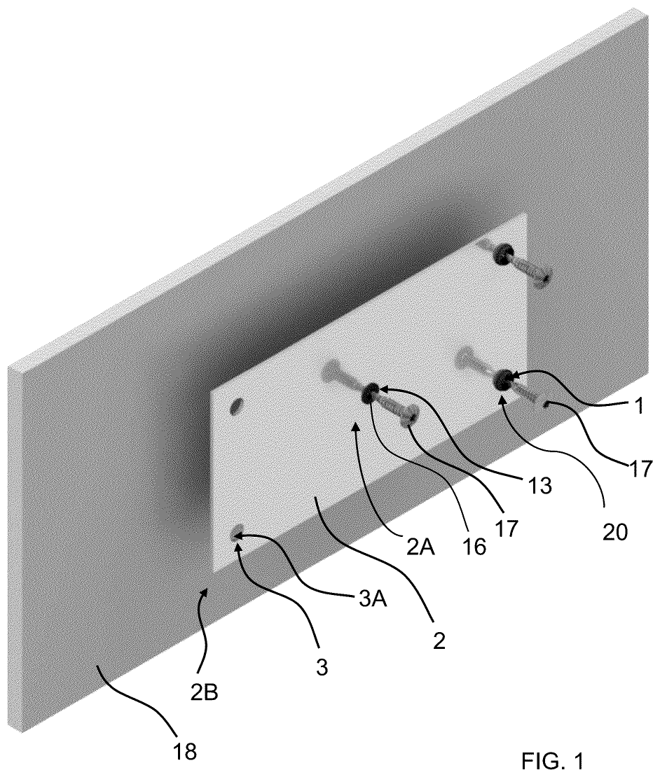

FIG. 1 illustrates a panel 2 that is going to be mounted on a wall 18. Typically, there is a support structure, for example made of wood or metal, between the panel 2 and the wall 18, although, this is not always strictly necessary, why this support structure is also not shown. In case that the panel is fastened directly to the wall, the wall takes the role of a support structure.

The panel 2 comprises a central part 2A of the panel 2 with a central hole 13 and a central bushing 16 that extends through the central hole 13, as the central hole 13 is oversized relatively to a fastening screw 17. The screw 17 extends through the central bushing 16 and into a support structure, for example into the wall 18, or into a support structure between the panel and the wall 18. The central mounting is fixing the panel 2 to the wall 18 in a non-movable way and, thus, defines the fixed position of the panel 2 to the wall 18.

As discussed above, temperature variations and humidity may cause expansion and contraction of the panel 2. While the mounting in the central part 2A of the panel 2 provides a fixed non-movable position of the central part 2A of the panel 2, the edge regions 2B, for example corner regions, of the panel 2A change distance relatively to the central part 2A of the panel 2. If not compensated for, this expansion or contraction would lead to tension and potential damage in the panel 2 around the mountings at the edges, for example corners. For the compensation, at the edges, for example corners, spacer inserts 1 of special character are provided, which are inserted into the fixation holes 3, which are also oversized relatively to the fastening screws 17. The spacer inserts 1 abut the rim 3A of the holes 3 in order not to fall out again but being fixed therein when inserted into the hole 3.

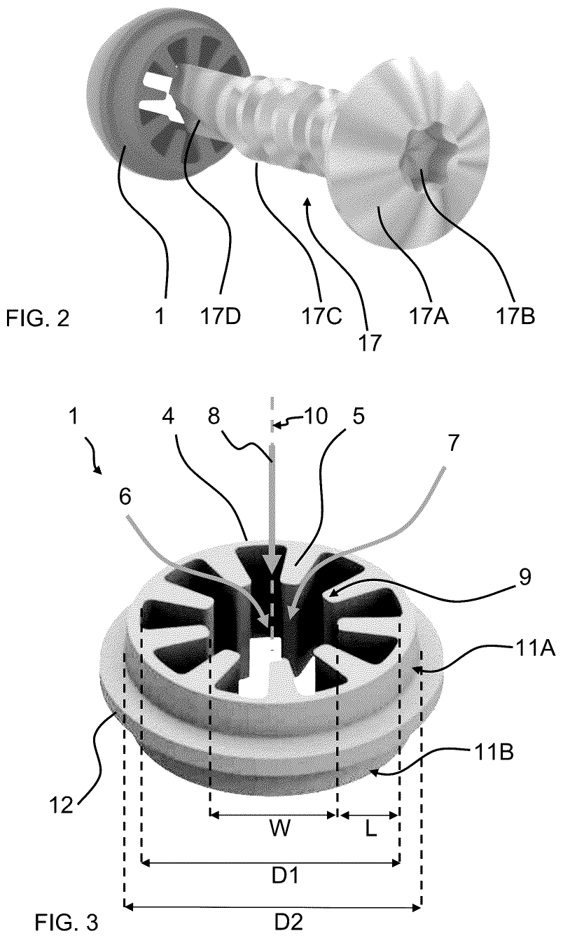

FIG. 2 illustrates a spacer insert 1 and a screw 17 that is about to be inserted through the spacer insert 1. The screw 17 comprises a head 17A with a tool connector 17B, for example, as illustrated, a Torx® connector. The screw 17 also comprises and a stem with a thread 17C and a drill tip 17D.

FIG. 3 exemplifies a spacer insert 1. It comprises an outer circular ring 4 for abutting the inner rim 3A of the fixation hole, see FIG. 1, and comprises vanes 5 extending from the ring 4 radially inwards towards a central region 7 of the ring 4. The vanes 5 do not extend to the center 6 of the ring 4 but leave open a central guiding passage 8 for the screw 17, or alternatively nail, during fastening of the panel 2. When the screw 17 is inserted through the central guiding passage 8, the freestanding ends 9 of the vanes 5 abut the screw 17 and support the screw 17 in the central region 7 so that the screw 17 is centered not only with respect to the spacer insert 1 but also with respect to the hole 3. Due to the ends 9 of the vanes 5 being straight and parallel with the central axis 10 and the inserted screw 17, the ends 9 that are abutting the screw 17 imply a proper guidance of the screw 17 through the central region 7.

The vanes 5 are resilient for allowing sufficient lateral movement of the rings 4 in the holes 2 of the edge regions 2B of the panel 2 relatively to the screw 17 that extends through the corresponding spacer insert 1 and, thus, allowing sufficient movement of the edge regions 2B relatively to the position-wise fixed central part 2A.

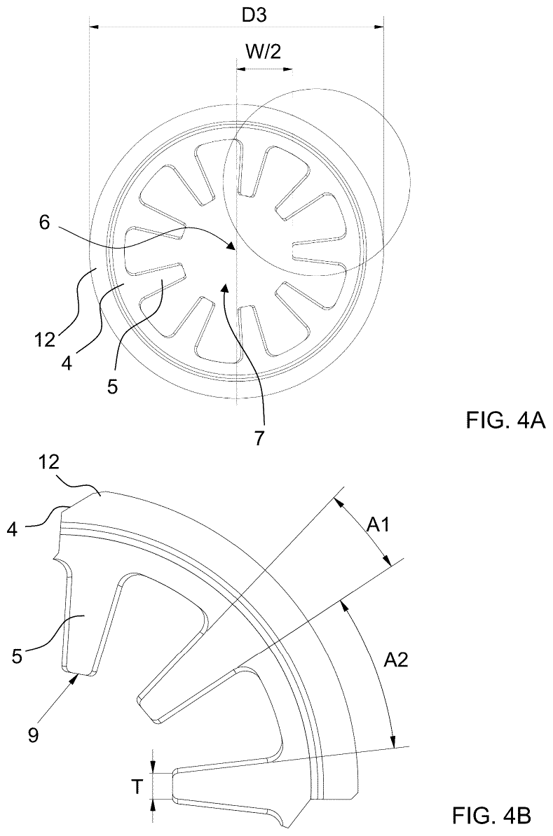

As an optional feature, illustrated in particular in FIG. 4B, in order to further facilitate lateral movement of the screw 17 relatively to the position-wise fixed screw 17, the vanes 5 are wedge-shaped, having a decreasing thickness T towards the central region 7.

For example, the angular span A1 of the vanes 5 is less than the angular span A2 between the vanes 5. For example, the ratio A1:A2 is in the range of 25%-75%, optionally in the range of 40%-60%.

As illustrated, the open central guiding passage 8 has a width W in the order of 50% of an inner diameter D1 of the ring 4.

For example, the length L of the vanes 5 is in the range of 15-40% of the inner diameter D1 of the ring 4.

As illustrated, the sum of the width W of the open central guiding passage 8 and twice the length L of the vanes 5 is equal to the inner diameter D1 of the ring 4.

The ring 4 has a first outer, slightly conical face 11A, which is inserted into the fixation hole 3 and, when inserted, abutting the inner rim 3A of the fixation hole 3. The conical face 11A has a maximum diameter D2, which is equal to or slightly larger than, but not smaller than, the inner diameter of the hole 3 in order for the spacer insert 1 to be fixedly held by the rim 3A of the hole 3 when inserted. The reason for the outer face 11A being conical is ease of insertion while at the same time fitting to the hole 3 such that the spacer insert 1 is fixed in the hole 3 when inserted. If the largest diameter D2 of the conical face 11A is slightly larger than the diameter of the hole 3, the flexible spacer insert 1 can be pressed into the hole 3 with a slight deformation of the conical face 11A so that it is resiliently held inside the hole 3.

In extension of the first conical face 11A, it has a collar 12 with diameter D3 substantially larger than the diameter D2 of the first outer conical face 11A in order for the collar 12 to be resting on the edge of the hole 3 when the first outer conical face 11A is inserted into the hole 3. On the opposite side of the collar 12 relatively to the first outer conical face 11A, the ring 4 has a second outer conical face 11B in extension of the collar 12. The first and second conical faces 11A, 11B and the collar 12 are symmetrical with respect to a symmetry plane perpendicular to the central axis 10. This has the advantage that the spacer insert 1 can be inserted into the holes with either of two different orientations, so that effort and time for adjusting the correct orientation during mounting are minimized.

In order to prevent the central area 2A of the panel from moving, the bushing 16 is potentially a hollow cylinder with a collar, similar to the collar 12 of the spacer insert 1.

1. Mounting element for mounting a panel (2), for example facade panel, with fixation holes (3) onto an underlying support structure (18), for example onto a wall, the mounting element comprises a spacer insert (1) for insertion into a fixation hole (3) of the panel (2), wherein the spacer insert (1) comprises a ring (4) for abutting an inner rim (3A) of the fixation hole (3) and comprises vanes (5) extending from the ring (4) inwards towards a central region (7) of the ring (4) but not to the center (6) of the ring (4) so as to leave open a central guiding passage (8) for a screw (17) or nail for fastening the panel (2) against a support structure by the screw (17) or nail, wherein the vanes (5) are resilient for allowing lateral movement of the ring (4) and the panel (2) relatively to the fastened screw (17) or nail extending through the guiding passage (8); wherein the vanes (5) are fastened only to the ring (4) and have freestanding ends (9) forming the guiding passage (8) through the central region (7).

2. A mounting element according to claim 1, wherein the ends (9) of the vanes (5) are straight and parallel with a central axis (10) through the center (6) of the ring (4).

3. A mounting element according to claim 1, wherein the vanes (5) extend from the ring (4) radially inwards towards the center (6) of the ring (4).

4. A mounting element according to claim 1, wherein the vanes (5) are wedge-shaped, narrowing towards the central region (7).

5. A mounting element according to claim 1, wherein the central guiding pas-sage (8) has a diameter in the range of 20-70% of an inner diameter (D1) of the ring (4), and the length (L) of the vanes (5) is in the range of 15-40% of the inner diameter (D1) of the ring (4), wherein the sum of a width (W) of the open central guiding passage (8) and twice the length (L) of the vanes (5) equals the inner diameter (D1) of the ring (4).

6. A mounting element according to claim 1, wherein the ring (4) has a first outer face (11A) for insertion into the fixation hole (3) and for abutting the inner rim (3A) of the fixation hole (3), wherein the ring (4) in extension of the first outer face (11A) has a collar (12) with larger diameter (D3) than a diameter (D2) of the first outer face (11A) for resting on an edge of the hole (3) when the first outer face (11A) is inserted into the hole (3), wherein the ring (4) has a second outer face (11B) in extension of the collar (12) on the opposite side of the collar (12) relatively to the first outer face (11A), and wherein the first and second outer faces (11A, 11B) and the collar (12) are symmetrical with respect to a symmetry plane perpendicular to the central axis (10).

7. A mounting element according to claim 6, wherein at least one of the first and the second outer face (11A, 11B) is tapering, for example conical, with the diameter decreasing with distance from the collar (12) for ease of insertion into the hole (3).

8. A mounting element according to claim 1, wherein the spacer insert is symmetrical with respect to a plane perpendicular to the central axis.

9. Method for mounting a panel (2), for example facade panel (2), onto a support structure, for example onto a wall (18), using spacer inserts (1) of mounting elements according to claim 1, the method comprising providing the panel (2) with holes (3) and fastening the panel (2) onto the support structure with screws (17) extending through the guiding passages (8) of spacer inserts (1) while the spacer inserts (1) are located in the holes (3).

10. Method according to claim 9, wherein the ring (4) has a first outer face (11A) for insertion into the fixation hole (3) and for abutting the inner rim (3A) of the fixation hole (3), wherein the ring (4) in extension of the first outer face (11A) has a collar (12) with larger diameter (D3) than a diameter (D2) of the first outer face (11A) for resting on an edge of the hole (3) when the first outer face (11A) is inserted into the hole (3), wherein the ring (4) has a second outer face (11B) in extension of the collar (12) on the opposite side of the collar (12) relatively to the first outer face (11A), and wherein the first and second outer faces (11A, 11B) and the collar (12) are symmetrical with respect to a symmetry plane perpendicular to the central axis (10);
wherein the method comprises inserting the first or the second outer face (11A, 11B) into the hole (3) and then inserting a screw (17) into and through the guiding pas-sage (8) and then tightening the screw (17) onto the support structure for fastening the panel (2) to the support structure.

11. Method according to claim 9, wherein the ring (4) has a first outer face (11A) for insertion into the fixation hole (3) and for abutting the inner rim (3A) of the fixation hole (3), wherein the ring (4) in extension of the first outer face (11A) has a collar (12) with larger diameter (D3) than a diameter (D2) of the first outer face (11A) for resting on an edge of the hole (3) when the first outer face (11A) is inserted into the hole (3), wherein the ring (4) has a second outer face (11B) in extension of the collar (12) on the opposite side of the collar (12) relatively to the first outer face (11A), and wherein the first and second outer faces (11A, 11B) and the collar (12) are symmetrical with respect to a symmetry plane perpendicular to the central axis (10);
wherein the method comprises selecting a screw (17) with a thread (17C) diameter larger than a diameter of the guiding passage (8) and inserting the screw (17) into the guiding passage (8) for providing a combination of screw (17) and spacer insert (1) where the spacer insert (1) is held by the screw (17) and only then, as part of the combi-nation, inserting the first or the second outer conical face (11A, 11B) into the hole (3) while the screw (17) extends through the guiding passage (8) and then tightening the screw (17), for example into the support structure.

12. Method according to claim 9, wherein the method comprises providing holes (3) in edge regions (2B) of the panel (2) and a central hole (13) in a central part (2A) of the panel (2), wherein the method further comprises fastening the panel (2) to the support structure with a screw (17) through a screw-centering bushing (16) in the central hole (13) and with further screws (17) through the spacer inserts (1) in the holes (3) in the edge regions (2B) of the panel (2), wherein the bushing (16) is different from the spacer inserts (1) in that it restricts the panel (2) more from moving laterally than the spacer inserts (1).

13. Method according to claim 9, wherein the ring (4) has a first outer face (11A) for insertion into the fixation hole (3) and for abutting the inner rim (3A) of the fixation hole (3), wherein the ring (4) in extension of the first outer face (11A) has a collar (12) with larger diameter (D3) than a diameter (D2) of the first outer face (11A) for resting on an edge of the hole (3) when the first outer face (11A) is inserted into the hole (3), wherein the ring (4) has a second outer face (11B) in extension of the collar (12) on the opposite side of the collar (12) relatively to the first outer face (11A), and wherein the first and second outer faces (11A, 11B) and the collar (12) are symmetrical with respect to a symmetry plane perpendicular to the central axis (10), and wherein at least one of the first and the second outer face (11A, 11B) is tapering, for example conical, with the diameter decreasing with distance from the collar (12) for ease of insertion into the hole (3);
wherein the method comprises inserting the first or the second outer face (11A, 11B) into the hole (3) and then inserting a screw (17) into and through the guiding passage (8) and then tightening the screw (17) onto the support structure for fastening the panel (2) to the support structure.

14. Method according to claim 9, wherein the ring (4) has a first outer face (11A) for insertion into the fixation hole (3) and for abutting the inner rim (3A) of the fixation hole (3), wherein the ring (4) in extension of the first outer face (11A) has a collar (12) with larger diameter (D3) than a diameter (D2) of the first outer face (11A) for resting on an edge of the hole (3) when the first outer face (11A) is inserted into the hole (3), wherein the ring (4) has a second outer face (11B) in extension of the collar (12) on the opposite side of the collar (12) relatively to the first outer face (11A), and wherein the first and second outer faces (11A, 11B) and the collar (12) are symmetrical with respect to a symmetry plane perpendicular to the central axis (10), and wherein at least one of the first and the second outer face (11A, 11B) is tapering, for example conical, with the diameter decreasing with distance from the collar (12) for ease of insertion into the hole (3);
wherein the method comprises selecting a screw (17) with a thread (17C) diameter larger than a diameter of the guiding passage (8) and inserting the screw (17) into the guiding passage (8) for providing a combination of screw (17) and spacer insert (1) where the spacer insert (1) is held by the screw (17) and only then, as part of the combination, inserting the first or the second outer conical face (11A, 11B) into the hole (3) while the screw (17) extends through the guiding passage (8) and then tightening the screw (17), for example into the support structure.
